(19) United States
(12) Patent Application Publication
(10) Pub. No.: US 2008/0294569 A1
(43) Pub. Date: Nov. 27, 2008

(54) Investment portfolio management method and system thereof

(76) Inventor: Michael Dever, Thornton, PA (US)

Correspondence Address: FROST BROWN TODD, LLC, 2200 PNC CENTER, 201 E. FIFTH STREET, CINCINNATI, OH, 45202, US

(21) Appl. No.: 11/805,956

(22) Filed: May 25, 2007

(51) Int. Cl. G06Q 40/00

(52) U.S. Cl. 705/36 R

(57) ABSTRACT

An investment portfolio management method and system that enhances an investment portfolio's risk adjusted involves reevaluating recent performance, and based thereon, if unfavorable rebating at least a portion of the reserve as reported performance if a reserve has been established, or if favorable establishing or increasing a reserve, followed by rebalancing the portfolio's leverage and amending the portfolio.

### TECHNICAL FIELD

This application relates generally to methods of investment portfolio management, and more, to an improved method for enhancing an investment portfolio's risk-adjusted return.

### BACKGROUND OF THE INVENTION

Modern portfolio theory calls for constructing an optimal investment portfolio by assembling a number of uncorrelated investments. Mean-variance modeling has become one of the industry standards used in portfolio optimization. Using this approach, an investor or portfolio manager seeks to optimize a portfolio's risk-adjusted return as measured by a variety of ratios, including, but not limited to, the Sharpe Ratio, Sortino Ratio, Calmar Ratio, and Sterling Ratio. Generally, a common feature among these ratios is that the numerator expresses some measure of return and the denominator expresses some measure of risk. Thus, optimizing a portfolio includes maximizing returns and minimizing risks such that any measure of risk-adjusted return is maximized.

One method of enhancing a portfolio's risk-adjusted return includes placing a portion of portfolio capital into a reserve, and adjusting the proportion of portfolio capital in reserve to capital invested in the portfolio based on the portfolio's performance. Generally, where a portfolio's recent performance is favorable, portfolio capital may be proportioned between reported performance and a reserve such that the proportion of capital in reserve is increased. Further, where a portfolio's recent performance is unfavorable, capital in reserve, or a portion thereof, may be rebated as reported performance such that the proportion of capital in reserve is decreased.

Increasing the proportion of capital in reserve when recent performance is favorable and/or decreasing the proportion of capital in reserve when recent performance is unfavorable may each have a positive effect on a portfolio's risk-adjusted return. For example, the Sharpe Ratio is calculated according to the following equations:

R_{I}=Reported Return for period I;

M_{R}=Mean of Reported Return for all periods;

N=Number of periods;

SD=Period Standard Deviation;

R_{RF}=Period risk free return;

$${M}_{R} = ( {\sum }_{I = 1}^{N} {R}_{I} ) \div N$$

$$SD = {( {\sum }_{I = 1}^{N} {( {R}_{I} - {M}_{R} )}^{2} \div ( N - 1 ) )}^{1 / 2}$$

Sharpe Ratio=(M_{R}−R_{RF})÷SD

Annualized Sharpe Ratio=Monthly Sharpe×12^{1/2}

By placing at least a portion of a raw return into a reserve when recent performance is favorable, the standard deviation may be reduced, thereby leading to a higher Sharpe Ratio. Furthermore, by rebating at least a portion of the reserve as reported returns when recent performance is unfavorable, the standard deviation may be reduced, thereby leading to a higher Sharpe Ratio.

In another example, the Sortino Ratio is calculated according to the following equations:

R_{I}=Reported Return for period I;

N=Number of periods;

R_{MAR}=Period Minimum Acceptable Return;

DD_{MAR}=Downside Deviation;

L_{I}=R_{I}−R_{MAR} (IF R_{I}−R_{MAR}<0) or 0 (IF R_{I}−R_{MAR}≧0)

$${DD}_{MAR} = {( ( {\sum }_{I = 1}^{N} {( {L}_{I} )}^{2} ) \div N )}^{1 / 2}$$

Sortino Ratio=(Compound Period Return−R_{MAR})÷DD_{MAR}

By rebating at least a portion of the reserve as reported returns when recent performance is unfavorable, the downside deviation may be reduced, thereby leading to a higher Sortino Ratio.

In yet another example, the Calmar Ratio is calculated using the absolute value of the maximum drawdown as the measure of risk where a drawdown is any losing period during an investment record and is defined as the percent retracement from an equity peak to an equity valley. A drawdown is in effect from the time an equity retrenchment begins until a new equity high is reached. Maximum drawdown is the largest drawdown that has occurred in any investment data record. The Calmar Ratio is calculated according to the following equation:

$$Calmar Ratio = \frac{Compound Annualized Rate of Reported Return}{ABS ( Maximum Drawdown )}$$

By rebating at least a portion of the reserve as reported returns when recent performance is unfavorable, the maximum drawdown may be reduced, thereby leading to a higher Calmar Ratio.

In a final example, the Sterling Ratio is calculated using the difference between 10% and an average drawdown as the measure of risk. The Sterling Ratio is calculated according to the following equations:

D1=Maximum Drawdown for the first 12 months;
D2=Maximum Drawdown for the second 12 months;
D3=Maximum Drawdown for the third 12 months;

Average Drawdown=(D1+D2+D3)÷3

$$Sterling Ratio = \frac{Compound Annualized Rate of Reported Return}{ABS ( ( Average Drawdown - 10 \% ) )}$$

By rebating at least a portion of the reserve as reported returns when recent performance is unfavorable, the average drawdown may be reduced, thereby leading to a higher Sterling Ratio.

The prior art fails to teach or suggest a method of enhancing an investment portfolio's risk-adjusted return of the present invention.

### BRIEF DESCRIPTION OF THE DRAWING

It is believed the present invention will be better understood from the following accompanying drawings, in which like reference numerals identify the same elements and which:

FIG. 1 depicts a schematic of a method for enhancing an investment portfolio's risk-adjusted return.

### DETAILED DESCRIPTION OF THE INVENTION

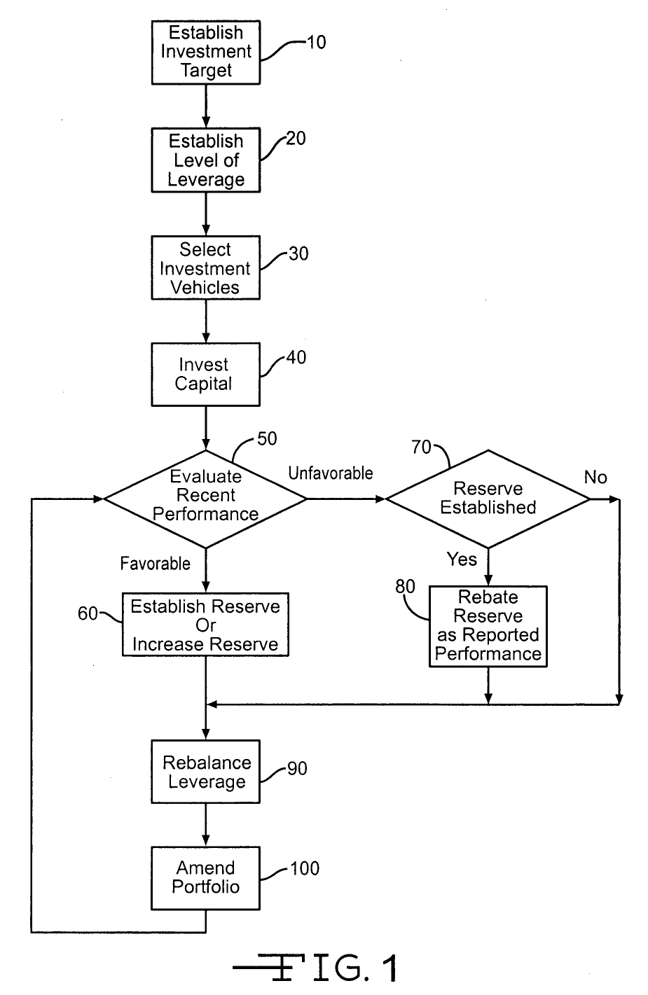

Referring now to FIG. 1, a method for enhancing an investment portfolio's risk-adjusted return is shown. First, an investment target for a portfolio is established 10. The investment target may be established by considering the investor's, or investors', long-term goals, short-term goals, age, personal preferences, credit level, income level, investable capital, as well as numerous other factors known to those skilled in the art. The investment target may be a targeted return, targeted leverage, level of acceptable risk, level of maximum drawdown, or the like. Once an investment target has been established 10, the portfolio's level of leverage may be determined 20. The portfolio's level of leverage may be: the ratio of the face value of financial instruments to equity to be held; the ratio of borrowed capital, such as margin, to equity to be held; the value of risk, such as portfolio volatility (e.g. day-to-day volatility); target value at risk; maximum drawdown; or the like. In one embodiment, the portfolio's level of leverage is determined based, at least in part, on the investment target.

After the portfolio's level of leverage is established 20, one or more suitable investment vehicles, including the position size, may be selected 30. Each investment vehicle may be selected based, at least in part, on how the vehicle relates to the investment target, how the vehicle relates to the established level of leverage, how the vehicle relates to other selected vehicles, the vehicle's relative risk, the vehicle's past performance, the vehicle's forecast(s), or any other criteria known in the art. Suitable investment vehicles may include equities, fixed income instruments, derivatives, mutual funds, real estate, annuities, or the like.

Once investment vehicles are selected for the portfolio 30, capital may be invested into the portfolio 40. Alternatively, capital may be proportioned between a reserve and investable capital, where the investable capital is then invested into the portfolio.

After a period of time, the portfolio's recent raw performance may be evaluated by comparing the portfolio's recent raw performance to the established investment target and determining whether or not the recent raw performance is favorable or unfavorable in light of the target 50. The portfolio's recent raw performance may be evaluated at pre-determined time intervals, randomly, at the discretion of the investor or portfolio manager, or the like.

Once the portfolio's most recent raw performance has been evaluated 50, portfolio capital may be distributed between a reserve and/or reported performance based on whether the recent performance has been determined to be favorable or unfavorable. In one embodiment, when the portfolio's recent raw performance is favorable, portfolio capital may be proportioned between a reserve and reported performance such that a reserve is established or such that capital in reserve is increased 60. For example, if the portfolio's recent raw performance is favorable and includes a return constituting a gain in portfolio capital, the gained capital may be proportioned between reported performance and a reserve. It should be appreciated that where recent raw performance is favorable, in some instances, it may be desirable to establish or increase capital in reserve and not proportion any capital towards reported performance. Further, when the portfolio's recent raw performance is unfavorable and a reserve has been previously established, capital from the reserve may be rebated as reported performance such that capital in reserve is decreased 80. For example, if the portfolio's recent raw performance is unfavorable and includes a return constituting a loss in portfolio capital, and if a reserve has been previously established, a portion of capital in reserve, up to the amount of the loss, may be rebated as reported performance. However, if recent raw performance is unfavorable, and a reserve does not exist, the portfolio's raw recent performance will be the portfolio's reported performance.

Next, the portfolio leverage may be rebalanced 90 based on the established investment target and the amount of capital in reserve. The relationship between the rebalanced portfolio leverage, the established investment target (represented in the following equations as “EIT”) and the amount of capital in reserve may be represented in a function, such as:

Rebalanced Leverage=aᵢ+bᵢ(EIT) (Eq. 1)

where 0%≦aᵢ≦1000% and bᵢ is a function of the amount of capital in reserve. Alternatively, the relationship may be represented in another function, such as:

Rebalanced Leverage=aᵢ+bᵢ(EIT)+cᵢ(EIT)² (Eq. 2)

where 0%≦aᵢ≦1000%, bᵢ is a function of the amount of capital in reserve, and cᵢ is a scalar, a function of the amount of capital in reserve, or the like.

In both Eq. 1 and Eq. 2, bᵢ is a function of the amount of capital in reserve (represented in the following equations as “ACR”). This function may be represented as:

bᵢ=aᵢ+bᵢᵢ(ACR) (Eq. 3)

where 0%≦aᵢᵢ≦100% and bᵢᵢ>0. Alternatively, bᵢ may be represented as:

bi=aii+bii(ACR)+cii(ACR)² (Eq. 4)

where 0%≦aᵢᵢ≦100%, bᵢᵢ>0, and cᵢᵢ is >0.

In Eq. 2, cᵢ may be a function of the amount of capital in reserve. This function may be represented as:

cᵢ=aᵢᵢᵢ+bᵢᵢᵢ(ACR) (Eq. 5)

where 0%≦aᵢᵢᵢ≦100% and bᵢᵢᵢ>0. Alternatively, cᵢ may be represented as:

cᵢ=aᵢᵢᵢ+bᵢᵢᵢ(ACR)+cᵢᵢ(ACR)² (Eq. 6)

where 0%≦aᵢᵢᵢ≦100%, bᵢᵢᵢ>0, and cᵢᵢ is >0.

As will be apparent to one skilled in the art, the relationships between the rebalanced portfolio leverage, the established investment target and the amount of capital in reserve may be based on any suitable function and is not limited to the forgoing exemplary functions. Generally, however, if the portfolio's most recent raw performance is favorable such that capital in reserve has been increased, the rebalanced leverage will be greater relative to the portfolio's immediately preceding level of leverage, and if the portfolio's most recent raw performance is unfavorable such that capital in reserve has been decreased, the rebalanced leverage will be smaller relative to the portfolio's immediately preceding level of leverage. Furthermore, due to the capital in reserve, the rebalanced leverage may be greater than had a reserve not been employed. Thus, over time, the portfolio's overall performance may be greater at substantially the same level of risk relative to an otherwise similar portfolio where a reserve has not been employed.

Once a reserve is established, the portfolio leverage may be rebalanced based on the size of the reserve relative to the established level of acceptable risk. If the most recent returns were favorable, rebalancing the portfolio leverage may include increasing the portfolio leverage relative to the established level of acceptable risk such that the adjusted risk remains the same as the previously established level of acceptable risk even while the portfolio's raw risk may be higher.

Here is an example using an acceptable measure of risk as being that the portfolio manager was willing to accept a 6% loss from peak equity levels. Over time, the portfolio may have returns such that 2% of the portfolio's value is accumulated in the portfolio's reserve. The portfolio may then take on additional risk, for example, through the use of additional leverage, that would result in a projected loss of 8%. Given the reserve of 2%, a loss of 8% in the portfolio would be partially offset by the 2% return being paid back into the portfolio, resulting in the adjusted risk remaining at 6%. To accomplish this, leverage would be increased an additional 33% compared to the initial leverage level, thereby increasing potential returns but without an increase in risk.

Once the portfolio leverage has been rebalanced 90, the investment portfolio may be amended 100. For example, if the rebalanced portfolio leverage is greater relative to the portfolio's immediately preceding level of leverage, position sizes for at least some of the previously selected investment vehicles may be increased, new position sizes for new investment vehicles may be added, or the like. Here, amending the portfolio may or may not involve borrowing additional capital to cover at least a portion of the increased position sizes and/or new positions. Illustratively, in the case of equities, an increase in portfolio leverage may allow for an increase of certain positions sizes, which may or may not include borrowing additional capital to do so. Similarly, in the case of derivatives, such as futures, an increase in portfolio leverage may allow for an increase in position sizes, which may or may not include: borrowing additional capital to do so; allocating a certain percentage of the reserve to secure the futures positions; committing a greater percentage of portfolio capital towards satisfying an increased security deposit (also referred to as “margin”); or the like. Further, if the rebalanced portfolio leverage is smaller relative to the portfolio's immediately preceding level of leverage, position sizes for at least some of the previously selected investment vehicles may be reduced, certain investment vehicles may be eliminated, or the like. As shown in FIG. 1, once the portfolio has been amended 100, the process may start again with a re-evaluation of the portfolio's performance after another period of time 50, and so forth.

Having shown and described various embodiments, further adaptations of the methods and systems described herein can be accomplished by appropriate modifications by one of ordinary skill in the art without departing from the scope of the present invention. Several of such potential modifications have been mentioned, and others will be apparent to those skilled in the art. Accordingly, the scope of the present invention should be considered in terms of the following claims and is understood not to be limited to the details of operation shown and described in the specification and drawings.

1. A method for enhancing risk-adjusted return, comprising the steps of:
a. establishing an investment target for an investment portfolio;
b. establishing a level of leverage for the portfolio based at least in part on the established investment target;
c. selecting one or more investment vehicles for the portfolio based at least in part on the established investment target;
d. determining position sizes for each selected investment vehicle based at least in part on the established investment target;
e. placing a portion of capital into a reserve;
f. investing a portion of capital into the portfolio;
g. calculating the portfolio's recent raw performance;
h. comparing the portfolio's recent raw performance to the established investment target;
i. determining whether the portfolio's recent raw performance is favorable based at least in part on the comparison of the recent raw performance to the established investment target;
j. increasing the amount of capital in the reserve when the portfolio's recent raw performance is favorable;
k. rebating at least a portion of capital in the reserve as reported performance such that the amount of capital in the reserve is decreased when the portfolio's recent raw performance is not favorable;
l. increasing the portfolio's level of leverage when the amount of capital in the reserve is increased;
m. decreasing the portfolio's level of leverage when the amount of capital in the reserve is decreased;
n. increasing the position size for at least one of the selected investment vehicles when the level of leverage is increased; and
o. reducing the position size for at least one of the selected investment vehicles when the level of leverage is decreased.

2. The method of claim 1 further comprising the steps of: selecting one or more new investment vehicles when the level of leverage is increased; and determining the position size for each newly selected investment vehicle when the level of leverage is increased.

3. The method of claim 1 further comprising the step of eliminating a selected investment vehicle when the level of leverage is decreased.

4. The method of claim 1 wherein the one or more investment vehicles for the portfolio are selected from the group consisting of:
a) equities;
b) fixed income instruments;
c) derivatives;
d) mutual funds;
e) real estate; and
f) annuities.
